(19) United States
(12) Patent Application Publication
(10) Pub. No.: US 2014/0377480 A1
(43) Pub. Date: Dec. 25, 2014

(54) AIRLINE TRAY TABLE COVER

(71) Applicants: Elizabeth Davino, Spring Lake Heights, NJ (US); Stacy Weber, Spring Lake Heights, NJ (US)

(72) Inventors: Elizabeth Davino, Spring Lake Heights, NJ (US); Stacy Weber, Spring Lake Heights, NJ (US)

(21) Appl. No.: 14/313,054

(22) Filed: Jun. 24, 2014

Related U.S. Application Data
(63) Continuation of application No. 13/921,428, filed on Jun. 19, 2013.

(51) Int. Cl. B64D 11/06

(52) U.S. Cl. CPC B64D 11/06; B64D 2011/0679; B64D 2011/0682
USPC 428/12; 428/99

(57) ABSTRACT

The present invention relates to a cover for an airline tray table. Specifically, the invention relates to an airline tray table cover that provides a sanitary cover that can be reversibly fitted to an airline tray table.

### CROSS-REFERENCE TO RELATED APPLICATIONS

This application claims the benefit of U.S. patent application Ser. No. 13/921,428, filed Jun. 19, 2013 and entitled “Airline Tray Table Cover,” the entire disclosure of which is incorporated herein by reference.

### FIELD OF THE INVENTION

The present invention relates to a cover for an airline tray table. Specifically, the invention relates to an airline tray table cover that provides a sanitary cover that can be reversibly fitted to an airline tray table.

### BACKGROUND OF THE INVENTION

One of the most recognizable aspects of air travel is the folding tray table. These folding tray tables are used by passengers for a variety of purposes including eating meals or as a work space. Even with routine cleaning by airline staff, these tray tables may be subject to retaining pathogens. An additional drawback of the traditional folding tray table is that the tray table is often made of a plastic material that can be excessively smooth and slippery. This creates a problem where items placed on the tray table can slide uncontrollably around and off of the tray table, possibly causing injury or damage to the items.

Therefore, there is a need in the art for cover for an airline tray table that provides a sanitary dining and work space, as well as a non-slip surface. These and other features and advantages of the present invention will be explained and will become obvious to one skilled in the art through the summary of the invention that follows.

### SUMMARY OF THE INVENTION

The present invention provides an apparatus for an airline tray table cover that is configured to reversibly attach to an airline tray table. In certain embodiments, the airline tray table cover may be attached to the airline tray table with a fastening strap. In other embodiments, the airline tray table cover may use an anti-slip material to cling to the airline tray table. Certain embodiments of the airline tray table cover may include anti-bacterial coatings and coverings.

According to an embodiment of the present invention, an apparatus for an airline tray table cover, the apparatus comprising: a cover body comprising a front wall, a rear wall and a retention means, wherein the front wall faces opposite the rear wall, wherein the front wall is comprises a substantially flat surface configured to provide a sanitary surface for receiving articles of an airline passenger, wherein the retention means is received on a portion of the cover body and secures the cover body to an airline tray table.

According to an embodiment of the present invention, the front wall is comprised of a first layer of material and a the bottom wall is comprised of a second layer of material.

According to an embodiment of the present invention, the cover body further comprises one or more middle layers of material.

According to an embodiment of the present invention, the retention means is a fastening strap.

According to an embodiment of the present invention, the retention means is further comprised of one or more fastener elements that allow the fastening strap to be reversibly connected to the cover body.

According to an embodiment of the present invention, the retention means is an anchoring component incorporated into the rear wall.

According to an embodiment of the present invention, the cover body comprises an anti-slip component.

According to an embodiment of the present invention, the cover body further comprises an anti-bacterial component.

According to an embodiment of the present invention, the cover body comprises one or more foldable joints that can be manipulated to customize the size of the airline tray table cover.

According to an embodiment of the present invention, the one or more foldable joints are parallel to a long-axis of the airline tray table cover.

According to an embodiment of the present invention, the one or more foldable joints are parallel to a short-axis of the airline tray table cover.

According to an embodiment of the present invention, the cover body comprises one or more detachable portions attached to the foldable joints, wherein the detachable portions may be removed from the cover body to reduce the size of the airline tray table cover.

According to an embodiment of the present invention, the cover body is constructed from a flexible material.

According to an embodiment of the present invention, the airline tray table cover is configured to fold into a collapsed configuration which is smaller than a non-collapsed configuration.

According to an embodiment of the present invention, the fastening strap is further configured to hold the airline tray table cover in a collapsed configuration which is smaller than a non-collapsed configuration.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is top perspective view of an airline tray table cover in accordance with an embodiment of the present invention;

FIG. 2 is bottom perspective view of an airline tray table cover in accordance with an embodiment of the present invention;

FIG. 3 is a side view of an airline tray table cover in accordance with an embodiment of the present invention;

FIG. 4 is a close-up view of a retention means of an airline tray table cover in accordance with an embodiment of the present invention;

FIG. 5 is an illustrative example of an airline tray table cover fitting to an airline tray table in accordance with an embodiment of the present invention;

FIG. 6 is an illustrative example of an airline tray table cover in place to an airline tray table in accordance with an embodiment of the present invention;

FIG. 7 is a top view of an airline tray table cover with foldable joints in accordance with an embodiment of the present invention;

FIG. 8 is a top view of an airline tray table cover with foldable joints in accordance with an embodiment of the present invention;

FIG. 9 is an illustrative example of an airline tray table with folding joints in accordance with an embodiment of the present invention; and

FIG. 10 is an illustrative example of an airline tray table with detachable portions in accordance with an embodiment of the present invention.

### DETAILED DESCRIPTION OF THE INVENTION

The present invention relates to a cover for an airline tray table. Specifically, the invention relates to an airline tray table cover that provides a sanitary cover that can be reversibly fitted to an airline tray table.

According to a preferred embodiment of the present invention, an airline tray table cover is comprised of a front wall, a rear wall, and a retention means. In alternate embodiments, the airline tray table cover may comprise fewer or additional components. One of ordinary skill in the art would appreciate that an airline tray table cover could be configured with a variety of components, and embodiments of the present invention are contemplated for use with and such component.

According to an embodiment of the present invention, the airline tray table cover includes a front wall and a rear wall. In a preferred embodiment, the airline tray table cover is comprised of two layers of material: a top layer of material and a bottom layer of material. In that preferred embodiment, the front wall is the top layer of material and the rear wall is the bottom layer of material. In an alternate preferred embodiment, the airline tray table cover is comprised of a single layer of material. In this alternate preferred embodiment, the front wall is the front side of the single layer of material and the rear wall is the rear side of the single layer of material. Further alternate embodiments may include airline tray table covers with more than two layers of material. In these alternate embodiments, the airline tray table covers would have at least at top layer, a bottom layer, and one or more middle layers. In the further alternate embodiments, the front wall is the top layer of material, the rear wall is the bottom layer of material, and the one or more middle layers are of varying composition. One of ordinary skill in the art would appreciate that an airline tray table cover could be constructed from a varying range of layers of material.

According to an embodiment of the present invention, the airline tray table cover includes a front wall. In a preferred embodiment, the front wall is the top layer of material in an embodiment of present invention that is made of two or more layers of material. In an alternate preferred embodiment, the front wall is the front side of the of the airline tray table cover in an embodiment of the present invention that is made of a single layer of material. One of ordinary skill in the art would appreciate there are numerous configurations for a front wall, and embodiments of the present invention are contemplated for use with any such configuration.

According to an embodiment of the present invention, the airline tray table cover includes a rear wall. In a preferred embodiment, the rear wall is the bottom layer of material in an embodiment of present invention that is made of two or more layers of material. In an alternate preferred embodiment, the rear wall is the rear side of the of the airline tray table cover in an embodiment of the present invention that is made of a single layer of material. One of ordinary skill in the art would appreciate there are numerous configurations for a rear wall, and embodiments of the present invention are contemplated for use with any such configuration.

According to an embodiment of the present invention, the airline tray table cover includes one or more middle layers of material. In a preferred embodiment, the middle layers of material are between a top layer of material comprising the front wall and a bottom layer of material comprising the rear wall. In the preferred embodiment, the middle layers may be a memory foam or similar material that provides support and cushioning for items placed on the airline tray table cover. Alternatively, the middle layers may provide additional structural support to the airline tray table cover. One of ordinary skill in the art would appreciate there are numerous suitable materials and functions for middle layer of material, and embodiments of the present invention are contemplated for use with any such material or function.

According to an embodiment of the present invention, the airline tray table cover includes a retention means. In a preferred embodiment, the retention means is a fastening strap. In an alternate preferred embodiment, the retention means is an anchoring component. The retention means is intended to reversibly secure the airline tray table cover to an airline tray table. One of ordinary skill in the art would appreciate that there are numerous designs for a functional retention means, and embodiments of the present invention are contemplated for use with any such design.

According to an embodiment of the present invention, the retention means is a fastening strap. In a preferred embodiment, the fastening strap is an elastic strap that is connected at two opposing edges of the airline tray table cover. In an alternate embodiment, the fastening strap is an adjustable strap connected at two opposing edges of the airline tray table cover. In certain embodiments the fastening strap is permanently attached to the airline tray table cover. In other embodiments, the fastening strap may be partially or totally removed from the airline tray table cover. The fastening strap is intended to go over or around the airline tray table in order to secure the airline tray table cover firmly in place. One of ordinary skill in the art would appreciate that there are numerous suitable designs for a fastening strap, and embodiments of the present invention are contemplated for use with any such fastening strap.

According to an embodiment of the present invention, the fastening strap may be partially or totally removable from the airline tray table cover. In a preferred embodiment, the fastening strap is removable through the use of one or more fastener elements. One of ordinary skill in the art would appreciate that there are numerous designs for a removable fastening strap, and embodiments of the present invention are contemplated for use with any such design.

According to an embodiment of the present invention, the fastening strap may include one or more fastener elements. In a preferred embodiment, the fastener element is a clip, clasp, hook, loop, snap, button, hook-and-loop fastener, or similar fastener. In the preferred embodiment there is a fastener element attached to each end of the fastening strap. Additionally, there are corresponding fastener elements attached at two opposing edges of the airline tray table cover. This arrangement allows the fastener elements on the fastening strap to reversibly engage with the fastener elements on the airline tray table cover permitting the fastening strap to be reversibly engaged with the airline tray table cover. In an alternate embodiment, the fastening strap is permanently attached to the airline tray table cover at one end and detachable at the other end. One of ordinary skill in the art would appreciate that there are many designs and functions for a fastener element, and embodiments of the present invention are contemplated for use with any such fastener element.

According to an embodiment of the present invention, the retention means is an anchoring means. In a preferred embodiment, the anchoring means is incorporated into the rear wall of the airline tray table cover. In the preferred embodiment, the anchoring means is a tacky or similar high friction material that is a coating on or otherwise incorporated into the rear wall. In an alternate embodiment, the anchoring means are weights that are incorporated into the edges or corners of the airline tray table cover. In further alternate embodiments, the anchoring means may be one or more suction cups or similar items. The anchoring means holds the airline tray table cover in place with the friction that is generated between the airline tray table cover and the airline tray table. One of ordinary skill in the art would appreciate there are numerous suitable anchoring means, and embodiments of the present invention are contemplated for use with any such anchoring means.

According to an embodiment of the present invention, the airline tray table cover may include an anti-slip component. In a preferred embodiment, the anti-slip component is incorporated into the front wall of the airline tray table cover. In the preferred embodiment, the anti-slip component is a tacky or similar high friction material that is a coating on or otherwise incorporated into the front wall. The anti-slip component is intend to create a non-slip surface on the surface of the airline tray table cover that reduces the chance that an item placed on the airline tray table cover will slide around uncontrollably. One of ordinary skill in the art would appreciate that there are numerous suitable anti-slip components, and embodiments of the present invention are contemplated for use with any such anti-slip component.

According to an embodiment of the present invention, the airline tray table cover may include an anti-bacterial component. In a preferred embodiment, the anti-bacterial component is a coating that is on or otherwise incorporated into the outer surfaces of the airline tray table cover. In the preferred embodiment, that anti-bacterial component may be a coating that is resistant bacteria and other pathogens. In an alternate preferred embodiment, the anti-bacterial component may be a material used to construct the airline tray table cover that is resistant to bacteria in other pathogens. The anti-bacterial component is intended to be incorporated into the airline tray table cover to provide a clean and hygienic dining and work space for an air traveler. One of ordinary skill in the art would appreciate that there are numerous suitable anti-bacterial components, and embodiments of the present invention are contemplated for use with any such anti-bacterial component.

According to a preferred embodiment of the present invention, the layers of material of the airline tray table cover are comprised of a flexible material. In the preferred embodiment, the flexible material may include, but is not limited to plastics, leather, and fabric. In an alternate embodiment, the layers of material of the airline tray table cover are comprised of rigid material. In the alternate embodiment, the rigid material may include a thick plastic or similar material. One of ordinary skill in the art would appreciate there are numerous suitable materials for the layers of material of the airline tray table cover, and embodiments of the present invention are contemplated for use with any such suitable material.

According to an embodiment of the present invention, the airline tray table cover may be customizable in size. In a preferred embodiment, the airline tray table cover is configured with one or more foldable joints. In an alternate embodiment, the airline tray table cover is configured with one or more detachable portions. One of ordinary skill in the art would appreciate that there are numerous designs for an airline tray table cover that is customizable in size, and embodiments of the present invention are contemplated for use with any such design.

According to an embodiment of the present invention, the airline tray table is customizable in size through the use of one or more foldable joints. In the preferred embodiment, the foldable joints are joints or seams that are incorporated into the airline tray table cover and permit the airline tray table cover to be precisely folded at specific intervals along the length of the airline tray table cover. By folding along these foldable joints, a user can customize and manipulate the size of the airline tray table cover to fit airline tray tables of varying size. In certain embodiments, the foldable joints are parallel to the long-axis of the airline tray cover. In certain embodiments, the foldable joints are parallel to the short-axis of the airline tray table cover. One of ordinary skill in the art would appreciate there are numerous suitable design for foldable joints, and embodiments of the present invention are contemplated for use with any such design.

According to an embodiment of the present invention, the airline tray table cover is customizable in size through one or more detachable portions. In the preferred embodiment, the airline tray table cover may be incorporated with one or more detachable portions. These detachable portions reversibly engage with the airline tray table cover through the use of magnets, hood-and-loop closures, clips, or any other suitable attachment means. One of ordinary skill in the art would appreciate that there are numerous suitable designs for detachable portions, and embodiments of the present invention are contemplated for use with any such design.

According to an embodiment of the present invention, the airline tray table cover may be collapsed into a smaller configuration. In a preferred embodiment, the airline tray table cover may be rolled, folded, collapsed, or otherwise reduced in size through the use of the foldable joints, the detachable portions, or due to the fact that the airline tray table is made from a flexible material. In embodiments where the airline tray table is designed to collapse into a smaller configuration, the fastening strap may be further configured to hold the airline tray table cover in the collapsed configuration by wrapping around or otherwise securing the airline tray table cover. By permitting the airline tray table cover to be collapsed into a smaller configuration, the airline tray table cover may be more easily carried and stored by an air traveler. One of ordinary skill in the would appreciate that there are numerous advantages and designs for a collapsible airline tray table cover, and embodiments of the present invention are contemplated for use with any such advantage or design.

### Exemplary Embodiments

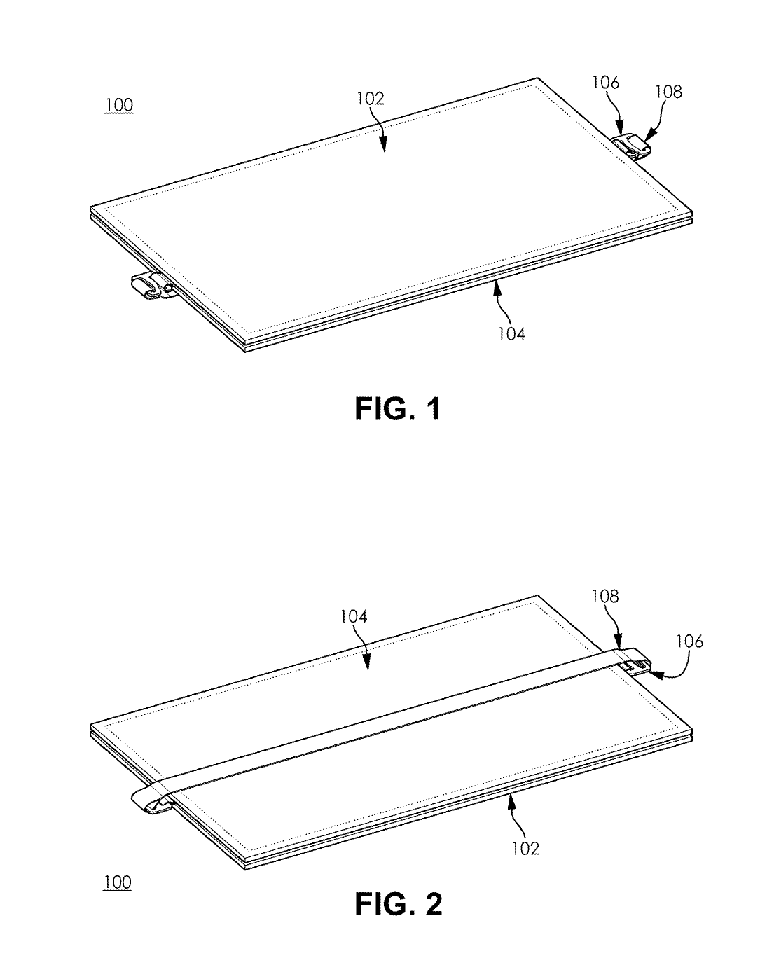

Turning now to FIG. 1, a top perspective views of an airline tray table cover in accordance with an embodiment of the present invention. In this illustration, a preferred embodiment of the airline tray table cover 100 is shown with having a largely rectangular shape. The airline tray table cover includes a front wall 102 and a rear wall 104. At opposite edges of the airline tray table cover 100 the fastening strap 108 attaches to the airline tray table cover 100 with a fastener element 106.

Turning now to FIG. 2, a bottom perspective views of an airline tray table cover in accordance with an embodiment of the present invention. In this illustration, a preferred embodiment of the airline tray table cover 100 is shown with having a largely rectangular shape. The airline tray table cover includes a front wall 102 and a rear wall 104. At opposite edges of the airline tray table cover 100 the fastening strap 108 attaches to the airline tray table cover 100 with a fastener element 106.

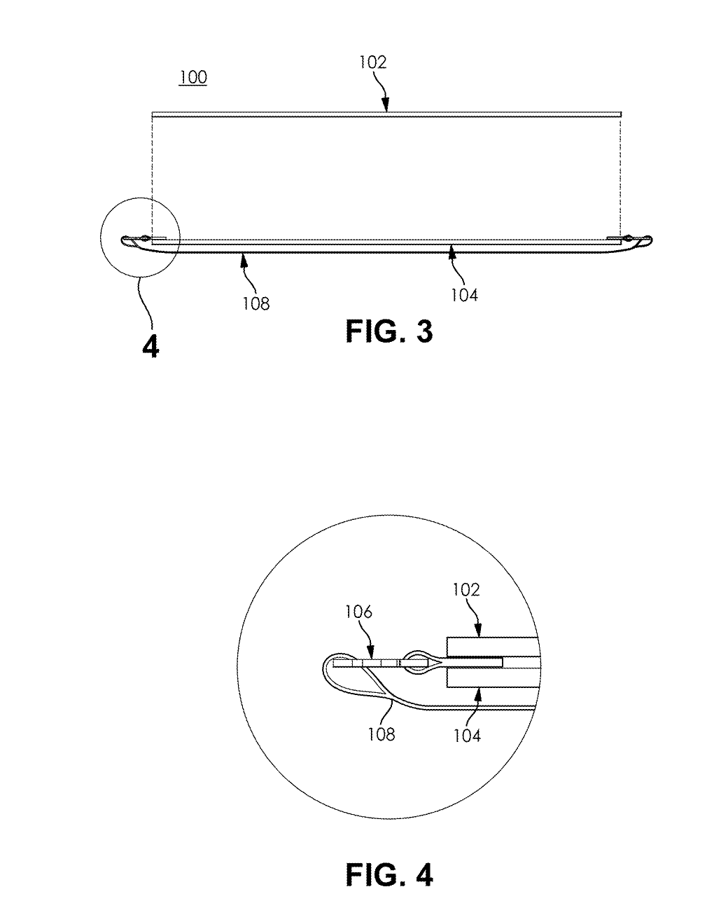

Turning now to FIG. 3, an edge view of an airline tray table cover in accordance with an embodiment of the present invention. In this illustration, a preferred embodiment of the airline tray table cover 100 is shown along the long-axis of the airline tray table cover 100. This figure illustrates an embodiment of the airline tray table cover 100 that is comprised of a top layer that forms the front wall 102 and a bottom layer that forms the rear wall 104. At opposite edges of the airline tray table cover 100 the fastening strap 108 attaches to the airline tray table cover 100 with a fastener element 106.

Turning now to FIG. 4, a close-up view of the retention means of an airline tray table cover 100 in accordance with an embodiment of the present invention. In this illustration, a preferred embodiment of a retention means is shown. In particular, a fastening strap 108 that attaches to a fastener element 106 that allows the fastening strap 108 to be removably attached to the airline tray table cover 100.

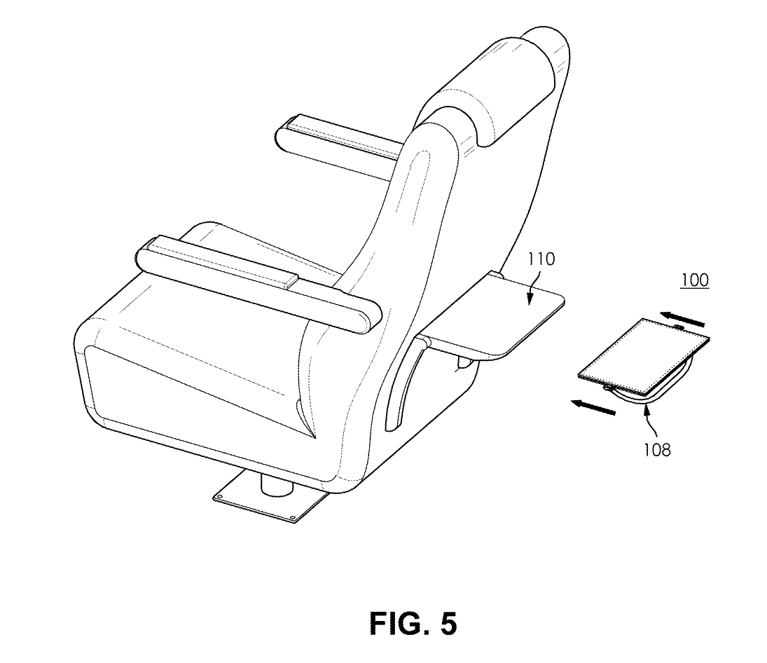

Turning now to FIG. 5, an illustrative example of an airline tray table cover attaching to a airline tray table, in accordance with an embodiment of the present invention. In a preferred embodiment, the airline tray table cover 100 attaches to the airline tray table 110 by sliding the airline tray table cover 100 over the edge of the airline tray table 110 and the fastening strap 108 under the edge of the airline tray table 110.

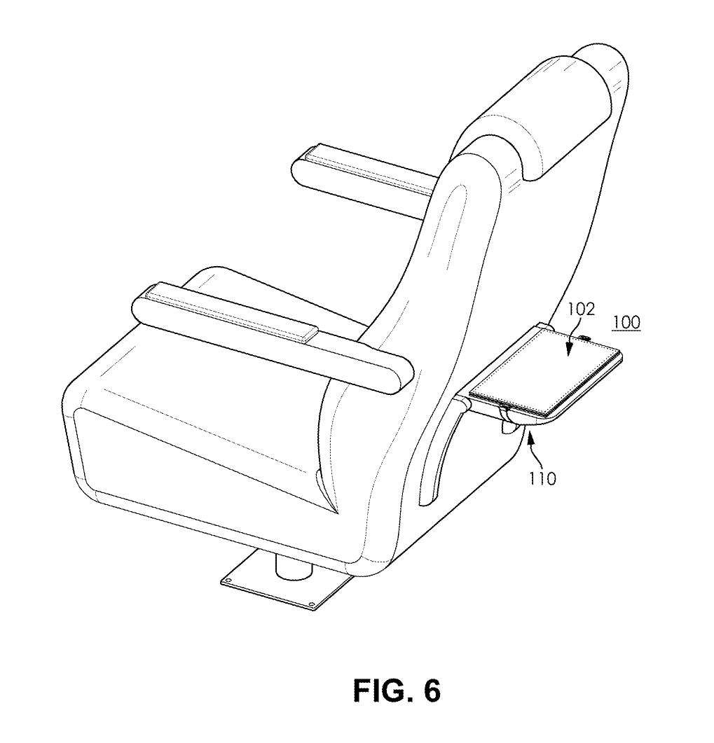

Turning now to FIG. 6, an illustrative example of an airline tray table cover in place on an airline tray table, in accordance with an embodiment of the present invention. In a preferred embodiment, the airline tray table cover 100 covers the airline tray table 110 with the front wall 102 providing a sanitary dining and workspace for the air traveler.

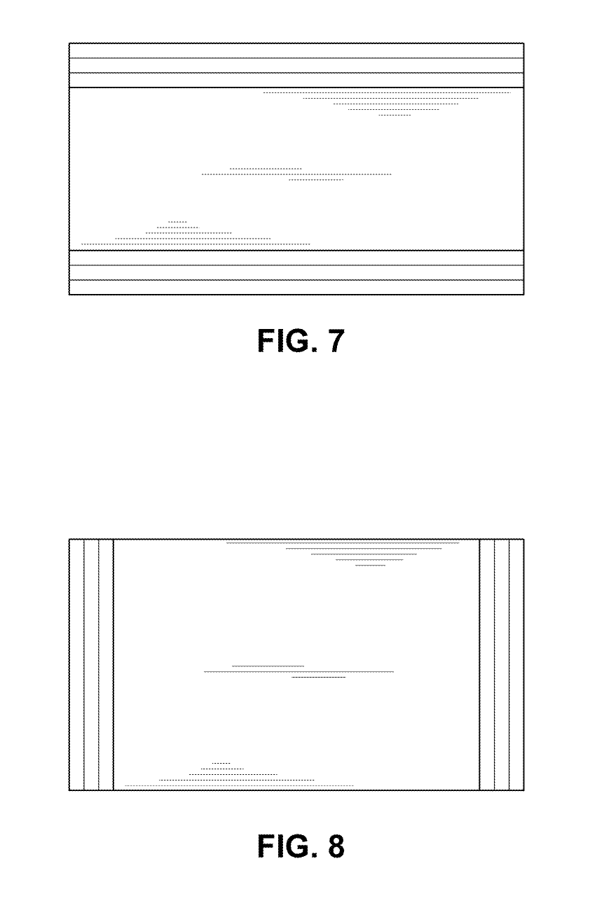

Turning now to FIG. 7, an top view of an airline tray table cover with a series of foldable joints along the long-axis of the airline tray table cover.

Turning now to FIG. 8, an top view of an airline tray table cover with a series of foldable joints along the short-axis of the airline tray table cover.

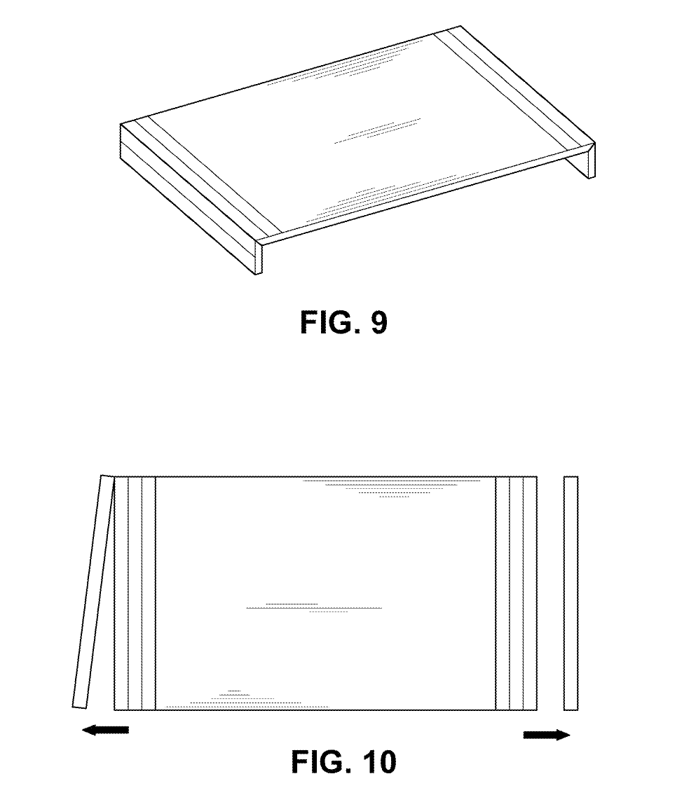

Turning now to FIG. 9, a perspective view of an airline tray table cover illustrating the series of foldable joints being folded under the airline tray table cover to customize the size of the airline tray table cover.

Turning now to FIG. 10, a top view of an airline tray table cover with one or more detachable portions. This figure illustrates one or more detachable portions being removed from the airline tray table cover to customize the size of the airline tray table cover.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. An apparatus for an airline tray table cover, said apparatus comprising:
a cover body comprising a front wall, a rear wall and a retention means,
wherein said front wall faces opposite said rear wall,
wherein said front wall is comprises a substantially flat surface configured to provide a sanitary surface for receiving articles of an airline passenger,
wherein said retention means is received on a portion of said cover body and secures said cover body to an airline tray table.

2. The apparatus of claim 1, wherein said front wall is comprised of a first layer of material and a said bottom wall is comprised of a second layer of material.

3. The apparatus of claim 2, wherein said cover body further comprises one or more middle layers of material.

4. The apparatus of claim 1, wherein said retention means is a fastening strap.

5. The apparatus of claim 4, wherein said retention means is further comprised of one or more fastener elements that allow said fastening strap to be reversibly connected to said cover body.

6. The apparatus of claim 1, wherein said retention means is an anchoring component incorporated into said rear wall.

7. The apparatus of claim 1, wherein said cover body comprises an anti-slip component.

8. The apparatus of claim 1, wherein said cover body further comprises an anti-bacterial component.

9. The apparatus of claim 1, wherein said cover body comprises one or more foldable joints that can be manipulated to customize the size of said airline tray table cover.

10. The apparatus of claim 9, wherein said one or more foldable joints are parallel to a long-axis of said airline tray table cover.

11. The apparatus of claim 9, wherein said one or more foldable joints are parallel to a short-axis of said airline tray table cover.

12. The apparatus of claim 9, wherein said cover body comprises one or more detachable portions attached to said foldable joints, wherein said detachable portions may be removed from said cover body to reduce the size of the airline tray table cover.

13. The apparatus of claim 1, wherein said cover body is constructed from a flexible material.

14. The apparatus of claim 1, wherein said airline tray table cover is configured to fold into a collapsed configuration which is smaller than a non-collapsed configuration.

15. The apparatus of claim 4, wherein said fastening strap is further configured to hold said airline tray table cover in a collapsed configuration which is smaller than a non-collapsed configuration.
